(19) United States
(12) Patent Application Publication
(10) Pub. No.: US 2025/0186291 A1
(43) Pub. Date: Jun. 12, 2025

(54) DEVICE FOR CONTROLLING WALKING AID AND METHOD THEREFOR

(71) Applicant: Samsung Electronics Co., Ltd., Suwon-si (KR)

(72) Inventors: Sukhoon SONG, Suwon-si (KR); Jungpil YU, Suwon-si (KR); Seokjae LEE, Suwon-si (KR); Kyunghun JANG, Suwon-si (KR)

(21) Appl. No.: 19/053,994

(22) Filed: Feb. 14, 2025

Related U.S. Application Data
(63) Continuation of application No. PCT/KR2023/012384, filed on Aug. 22, 2023.

(30) Foreign Application Priority Data
Aug. 24, 2022 (KR) 10-2022-0106473
Oct. 25, 2022 (KR) 10-2022-0138308

(51) Int. Cl. A61H 3/00; A61H 1/02

(52) U.S. Cl. CPC A61H 3/00; A61H 1/0262; A61H 2003/007; A61H 2201/1207; A61H 2201/1628; A61H 2201/164; A61H 2201/165; A61H 2201/5058; A61H 2201/5069; A61H 2201/5079

(57) ABSTRACT

A walking aid device and/or a control method therefor. According to an example embodiment, a method for controlling a walking aid device may include: obtaining sensor data from one or more sensors; obtaining a plurality of pieces of speed information on the basis of the sensor data; determining whether a walking aid device has reached a first state, on the basis of at least one of the plurality of pieces of speed information; determining a change control torque corresponding to the at least one of the plurality of pieces of speed information, on the basis of the determination result; and controlling the walking aid device with the change control torque.

### CROSS-REFERENCE TO RELATED APPLICATIONS

This application is a continuation application of International Application No. PCT/KR2023/012384 designating the United States, filed on Aug. 22, 2023, in the Korean Intellectual Property Receiving Office and claiming priority to Korean Patent Application No. 10-2022-0106473, filed on Aug. 24, 2022, and Korean Patent Application No. 10-2022-0138308, filed on Oct. 25, 2022, the disclosures of which are all hereby incorporated by reference herein in their entireties.

### BACKGROUND

### Technical Field

Certain example embodiments may relate to a method of controlling walking assistance.

### Description of Related Art

A person may wear a walking assistance device to improve muscle strength for walking. Assistance with muscle strength through the walking assistance device may improve walking and enable a person who is unable to walk normally to walk, and/or to help a person exercise.

A maximum or high output torque measured externally may differ from the torque internally controlled for walking and exercising while wearing the walking assistance device. At this time, as the speed of a motion increases, a control torque increases, and the final output torque also increases likewise. Accordingly, the torque limits of a drive motor and a reducer may be exceeded.

### SUMMARY

Certain example embodiments may provide a method of verifying a high-speed walking situation of a walking assistance device through sensor data.

Certain example embodiments may provide a control method of reducing an output torque load in a high-speed walking situation of a walking assistance device.

The goals to be achieved through the present disclosure are not limited to those described above, and goals not mentioned above may be clearly understood by one of ordinary skill in the art to which the present disclosure pertains from the following description and accompanying drawings.

A control method of a walking assistance device according to an example embodiment may include obtaining sensor data from one or more sensors, obtaining a plurality of pieces of velocity information based on the sensor data, verifying whether the walking assistance device corresponds to a first state based on at least one of the plurality of pieces of velocity information, determining a change control torque corresponding to at least one of the plurality of pieces of velocity information based on a result of the verifying, and controlling the walking assistance device with the change control torque.

An electronic device according to an example embodiment may include a memory configured to store at least one instruction, and at least one processor, comprising processing circuitry, configured to execute the at least one instruction, wherein the at least one processor may be configured to, individually and/or collectively, by executing the at least one instruction, obtain sensor data from one or more sensors, obtain a plurality of pieces of velocity information based on the sensor data, verify whether a walking assistance device corresponds to a first state based on at least one of the plurality of pieces of velocity information, and determine a change control torque corresponding to at least one of the plurality of pieces of velocity information based on a result of the verifying.

A walking assistance device according to an example embodiment may include a sensor portion including at least one sensor, a driving portion comprising a motor, and a processor, wherein the processor may be configured to obtain sensor data from one or more sensors, obtain a plurality of pieces of velocity information based on the sensor data, verify whether the walking assistance device corresponds to a first state based on at least one of the plurality of pieces of velocity information, and determine a change control torque corresponding to at least one of the plurality of pieces of velocity information based on a result of the verifying, wherein the driving portion may be configured to provide the change control torque.

Certain example embodiments may provide a method of verifying a high-speed walking situation of a walking assistance device through sensor data.

Certain example embodiments may provide a control method of reducing an output torque load in a high-speed walking situation of a walking assistance device.

The effects of the present disclosure are not limited to those described above, and effects not mentioned above may be clearly understood by one of ordinary skill in the art to which the present disclosure pertains from the following description and accompanying drawings.

### BRIEF DESCRIPTION OF DRAWINGS

FIG. 1A illustrates a side view of a walking assistance device according to an example embodiment.

FIG. 1B illustrates a front view of a walking assistance device according to an example embodiment.

FIG. 2 illustrates an input/output relationship of a walking assistance device according to an example embodiment.

FIG. 3 is a flowchart illustrating a control method of a walking assistance device according to an example embodiment.

FIGS. 4A and 4B are diagrams illustrating a method of verifying whether a walking assistance device corresponds to a first state according to an example embodiment(s).

FIG. 5 is a diagram illustrating a current control torque and a change control torque according to an example embodiment.

FIG. 6 is a block diagram illustrating an electronic device according to an example embodiment.

### DETAILED DESCRIPTION

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although the terms “first”, “second”, and the like, may be used herein to describe various components, the components should not be limited by these terms. These terms are only used to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. Thus, for example, “connected” herein covers both direct and indirect connections. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

The embodiments may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. In the drawings, like reference numerals are used for like elements.

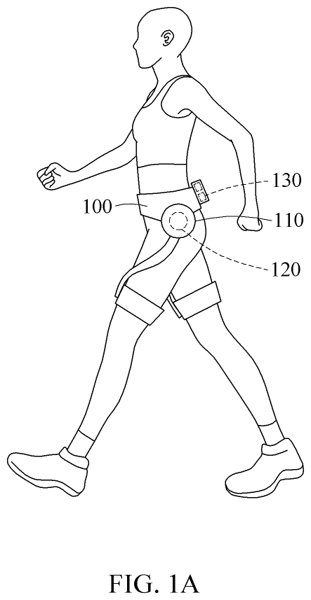

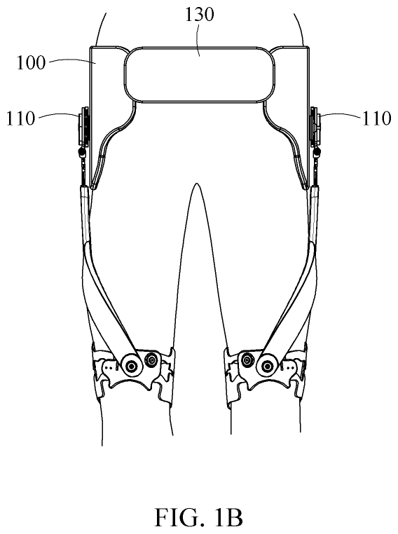

FIG. 1A illustrates a side view of a walking assistance device according to an embodiment.

Referring to FIG. 1A, according to an embodiment, a walking assistance device 100 may be worn by a user to assist the user in walking. According to an embodiment, the walking assistance device 100 may be a wearable device and may be hereinafter referred to as a wearable robot.

Although FIG. 1A illustrates a hip-type walking assistance device, the type of the walking assistance device is not limited thereto. The walking assistance device may be a type that supports the entire lower limbs or a type that supports a portion of the lower limbs. In addition, the walking assistance device may be one of a type that supports a portion of the lower limbs, a type that supports up to the knees, a type that supports up to the ankles, and a type that supports the entire body.

The description provided with reference to FIG. 1A may apply to a hip-type walking assistance device, but is not limited thereto, and may apply to all types of devices for assisting a user in walking.

As shown in FIG. 1A, according to an embodiment of the present disclosure, the walking assistance device 100 may include a driving portion 110, a sensor portion 120, and a control portion 130. However, not all the illustrated components are essential.

The walking assistance device 100 may be implemented by more components than the illustrated components, or the walking assistance device 100 may be implemented by fewer components.

For example, according to an embodiment, the walking assistance device 100 may further include a user interface, a communication interface, and a memory, in addition to the driving portion 110, the sensor portion 120, and the control portion 130.

The term “portion” used for the components (the driving portion 110, the sensor portion 120, and the control portion 130) shown in FIG. 1A may be, for example, a unit including one or a combination of two or more of hardware, software, or firmware. The “portion” may be interchangeably used with terms such as, for example, module, unit, logic, logical block, component, or circuit. The “portion” may be a minimum unit of an integrally formed component or part thereof.

The “portion” may be a minimum unit for performing one or more functions or part thereof. The “portion” may be implemented mechanically or electronically. For example, the “portion” may include any one or any combination of an application-specific integrated circuit (ASIC) chip, field-programmable gate arrays (FPGAs), or a programmable-logic device that performs known operations or operations to be developed. Hereinafter, the components will be described sequentially.

According to an embodiment, the driving portion 110 may be positioned on the right and left hip portions of the user to drive both hip joints of the user. For example, according to an embodiment, the driving portion 110 may include a motor to generate a rotational torque. The driving portion 110 may further include a reducer to amplify a torque by reducing the rotation speed of the motor.

According to an embodiment, the sensor portion 120 may include one or more sensors. According to an embodiment, the sensor portion 120 may include at least one of an inertial measurement unit (IMU), an acceleration sensor, a gyroscope sensor, a magnetic sensor, a position sensor (e.g., a global positioning system (GPS)), a pressure sensor, and a proximity sensor, but is not limited thereto. For example, according to an embodiment, the walking assistance device 100 may further include another sensor (e.g., an electromyogram (EMG) sensor) to sense a change in the quantity of motion of the user or a change in a biosignal according to a walking motion.

According to an embodiment, the sensor portion 120 may include one or more potentiometers. The potentiometers may sense at least one of R-axis and L-axis joint angles or R-axis and L-axis joint angular velocities according to a walking motion of the user.

According to an embodiment, the IMU may measure acceleration information and pose information while the user is walking. For example, the IMU may sense at least one of X-axis, Y-axis, and Z-axis accelerations or X-axis, Y-axis, and Z-axis angular velocities according to the walking motion of the user. According to an embodiment, the walking assistance device 100 may detect the landing point in time of the foot of the user based on the acceleration information measured by the IMU.

According to an embodiment, the pressure sensor may be positioned on the sole of the foot of the user to detect the landing point in time of the foot of the user.

According to an embodiment, the control portion 130 may control the driving portion 110 so that the driving portion 110 may output a torque (or an assistance force) to assist the user in walking. For example, the hip-type walking assistance device 100 may include two driving portions 110 (for the left hip and the right hip), and the control portion 130 may output control signals to control drivers to generate torques. The driving portions 110 may generate torques based on the control signals output from the control portion 130.

FIG. 1B illustrates a front view of a walking assistance device according to an embodiment.

According to an embodiment, the walking assistance device 100 may include a driving portion 110 for the right leg and a driving portion 110 for the left leg.

According to an embodiment, the control portion 130 may be designed to control one of the driving portions 110 on both sides. If the control portion 130 controls only one of the driving portions 110, the control portion 130 may be provided in plurality. As another example, the control portion 130 may be designed to control both driving portions on both sides.

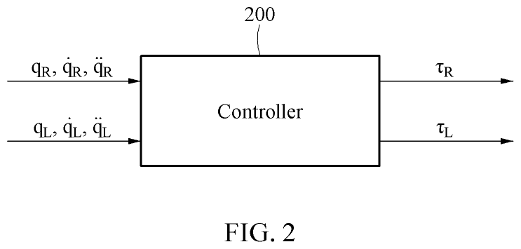

Although it is described that FIG. 1B illustrates the front view of the walking assistance device 100 according to an embodiment, it may be understood as illustrating the rear view of the walking assistance device 100 of FIG. 2 depending on the design.

According to an aspect, a preset torque signal may be set to the driving portion 110 according to the operating state of the walking assistance device 100. The driving portion 110 may generate a torque according to the set torque signal. For example, the torque signal may be set to the driving portion 110 according to the walking frequency at which the walking assistance device 100 operates.

According to another aspect, the walking assistance device 100 may adjust the torque signal by referring to the result of the operation of the walking assistance device 100. In other words, the operation result may be fed back.

For example, the walking assistance device 100 may calculate the torque signal using a positive feedback. The walking assistance device 100 may construct a closed loop to calculate the torque signal.

FIG. 2 illustrates an input/output relationship of a walking assistance device according to an embodiment.

The description provided with reference to FIGS. 1A and 1B may identically apply to FIG. 2, and a duplicate description will be omitted. For example, according to an embodiment, a walking assistance device 200 may be the walking assistance device 100 described with reference to FIGS. 1A and 1B.

According to an embodiment, the walking assistance device 200 may sense both hip joint motions of a user wearing the walking assistance device, identify the intention of a walking motion of the user through this, and provide a control torque for appropriate walking assistance to the user.

Referring to FIG. 2, both hip joint angles qR and qL of a user may be measured by a sensor portion (e.g., the sensor portion 120 of FIG. 1A) such as a position sensor, and hip joint angular velocities qR′ and qL′ and angular accelerations qR″ and qL″ may be measured or calculated as differentials in joint angles.

According to an embodiment, the walking assistance device 200 may identify the intention of a walking motion of the user based on the measured both hip joint angle information of the user, and generate a control torque for walking assistance appropriate for the user through this. The generated control torque generated for walking assistance may be transmitted to a driving portion (e.g., the driving portion 110 of FIG. 1A) and provided to both hip joints of the user.

If the output torque measured externally is greater than the control torque, the torque limits of a drive motor and a reducer may be exceeded. The output torque may be the sum of the control torque and the torque by an external force (e.g., a motion of the user), and the output torque may increase as the speed of a motion increases. If the output torque exceeds a threshold value and is beyond the torque limits of the drive motor and the reducer, it may cause the motor and the reducer to fail.

As described in detail below, according to an embodiment, the walking assistance device 200 may detect a high-speed walking situation and adjust the control torque to reduce an output torque load in the high-speed walking situation.

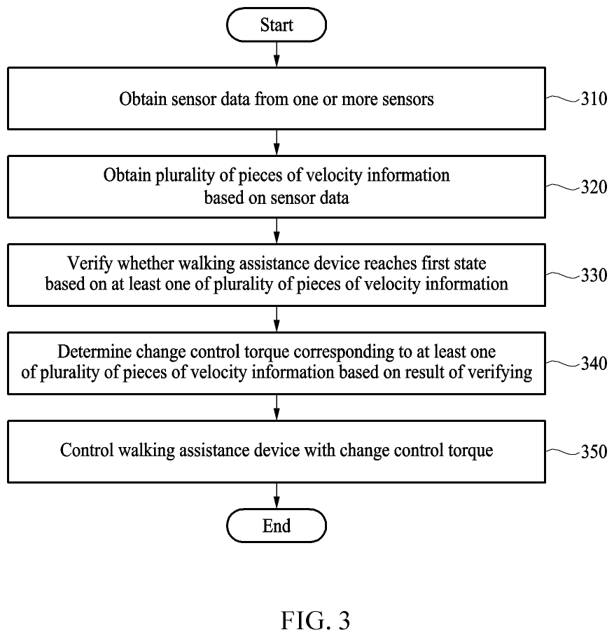

FIG. 3 is a flowchart illustrating a control method of a walking assistance device according to an embodiment.

For ease of description, it is described operations 310 to 350 are performed by the walking assistance device 200 shown in FIG. 2. However, operations 310 to 350 may also be performed by any suitable electronic device and in any suitable system.

Furthermore, the operations of FIG. 3 may be performed in the shown order and manner. However, the order of some operations may change, or some operations may be omitted, without departing from the spirit and scope of the shown embodiment. The operations shown in FIG. 3 may be performed in parallel or simultaneously. The description provided with reference to FIGS. 1A to 2 may identically apply to FIG. 3, and a duplicate description will be omitted.

In operation 310, according to an embodiment, the walking assistance device 200 may obtain sensor data from one or more sensors. According to an embodiment, the sensor data may be data sensed by a sensor portion (e.g., the sensor portion 120 of FIG. 1A). For example, the sensor data may include encoder data of the motor, the R-axis and L-axis joint angles or R-axis and L-axis joint angular velocities according to a walking motion of the user, and acceleration information or pose information while the user is walking.

In operation 320, according to an embodiment, the walking assistance device 200 may obtain a plurality of pieces of velocity information based on the sensor data. According to an embodiment, the velocity information may include at least one of joint velocity information, walk speed information, power information, and motion tempo information.

According to an embodiment, the joint velocity information may be joint angle variation information per time. The joint angles may be R-axis and L-axis joint angles according to a walking motion of the user. According to an embodiment, the power information may be determined by the product of the joint velocity and a control torque.

According to an embodiment, the walk speed information may indicate a position change per time according to a walking motion of the user, and if the user moves in place, the walk speed may be “0”. According to an embodiment, the walk speed information may be obtained based on the encoder data of the motor.

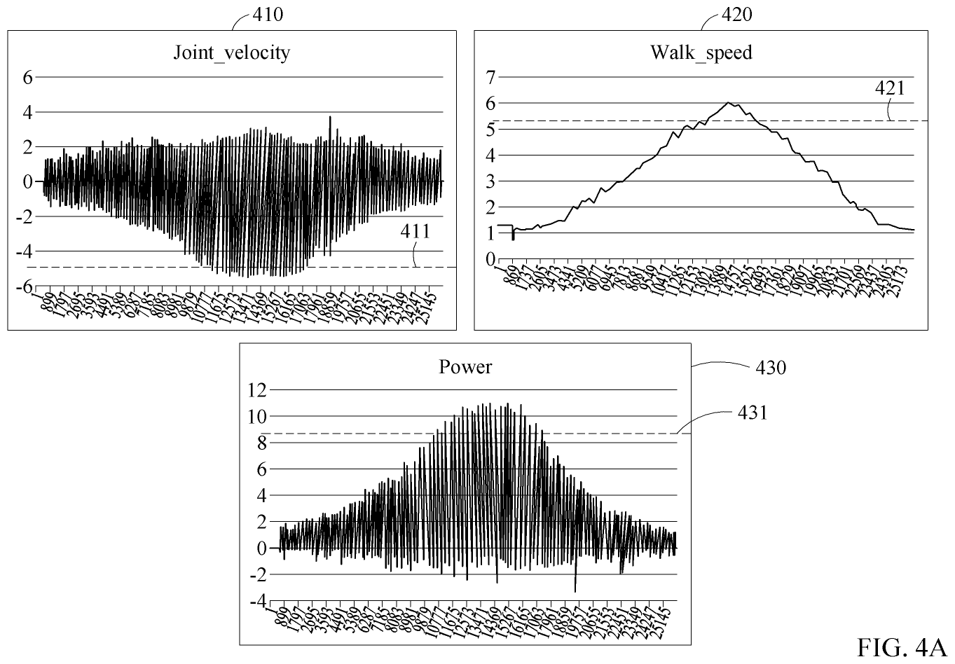

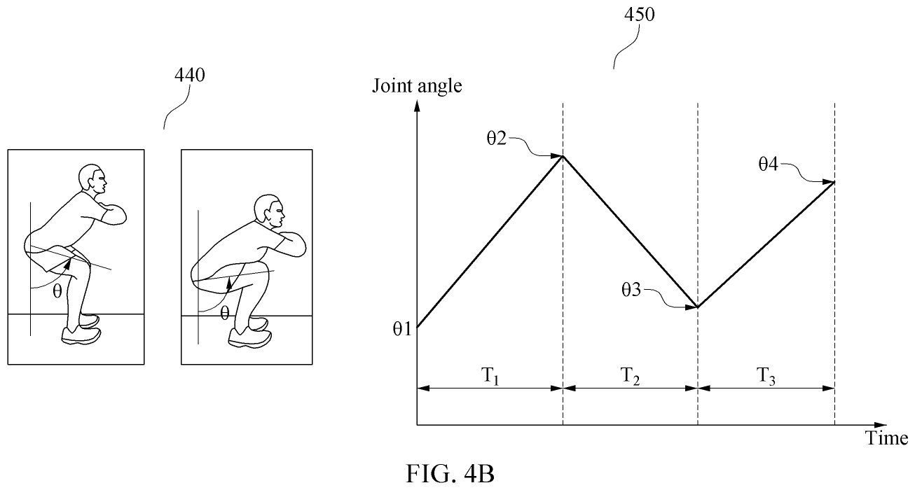

According to an embodiment, the motion tempo information may be information about the repetition period corresponding to a predetermined motion repeated by the user. According to an embodiment, the motion tempo information will be described further in detail below with reference to FIG. 4B.

In operation 330, according to an embodiment, the walking assistance device 200 may verify whether the walking assistance device corresponds to a first state based on at least one of the plurality of pieces of velocity information. According to an embodiment, the walking assistance device corresponding to the first state may indicate the high-speed walking situation described above.

According to an embodiment, the walking assistance device 200 may verify whether the walking assistance device corresponds to the first state, by comparing each of the plurality of pieces of velocity information (e.g., the joint velocity information, the walk speed information, the power information, and the motion tempo information) with a threshold value corresponding to each of the plurality of pieces of velocity information. The detailed method of verifying whether the walking assistance device corresponds to the first state according to an embodiment will be described below with reference to FIGS. 4A and 4B.

FIGS. 4A and 4B are diagrams illustrating a method of verifying whether a walking assistance device corresponds to a first state according to an embodiment.

Referring to FIG. 4A, according to an embodiment, the walking assistance device 200 may obtain joint velocity information 410, walk speed information 420, and power information 430 based on sensor data.

According to an embodiment, the walking assistance device 200 may compare the joint velocity information 410 with a first threshold value 411, compare the walk speed information 420 with a second threshold value 421, and compare the power information 430 with a third threshold value 431. Here, the first threshold value 411, the second threshold value 421, and the third threshold value 431 may be determined to be different values.

According to an embodiment, the walking assistance device 200 may verify that the walking assistance device 200 corresponds to the first state if at least one of the joint velocity information 410, the walk speed information 420, and the power information 430 exceeds each corresponding threshold value 411, 421, or 431.

For example, if the power information 430 exceeds the fourth threshold value 431 even when the joint velocity information 410 and the walk speed information 420 do not exceed the first threshold value 411 and the second threshold value 421, respectively, it may be verified that the walking assistance device 200 currently corresponds to the first state.

According to an embodiment, the walking assistance device 200 may verify that the walking assistance device 200 corresponds to the first state, if at least one of the pieces of velocity information (e.g., the joint velocity information 410, the walk speed information 420, and the power information 430) exceeds the threshold value continuously for more than a predetermined time.

For example, if the joint velocity information 410 fails to exceed the first threshold value 411 continuously for the predetermined time even when the joint velocity information 410 exceeds the first threshold value 411, it may not be verified that the walking assistance device currently corresponds to the first stage. According to an embodiment, the predetermined time may vary depending on the types of the pieces of velocity information (e.g., the joint velocity information 410, the walk speed information 420, and the power information 430).

For example, for the joint velocity information 410, it may be verified that the walking assistance device 200 corresponds to the first state if the joint velocity information 410 exceeds the first threshold value 411 continuously for more than a first time. For the walk speed information 420, it may be verified that the walking assistance device 200 corresponds to the first state if the walk speed information 420 exceeds the second threshold value 421 continuously for more than a second time. For the power information 430, it may be verified that the walking assistance device 200 corresponds to the first state if the power information 430 exceeds the third threshold value 431 continuously for more than a third time.

Although FIG. 4A shows the joint velocity information 410, the walk speed information 420, and the power information 430 as examples of the velocity information, the velocity information is not necessarily limited thereto. For example, the velocity information may include motion tempo information.

Referring to FIG. 4B, according to an embodiment, the walking assistance device 200 may obtain motion tempo information based on sensor data.

According to an embodiment, the motion tempo information may be information about the repetition period corresponding to a predetermined motion repeated by the user. When the user repeats a predetermined motion (e.g., a squat exercise 440), the walking assistance device 200 may count the predetermined motion and calculate a motion tempo through the interval between counts. Through this, according to an embodiment, the walking assistance device 200 may detect a high-speed walking situation in which the user moves in place without walking.

More specifically, the walking assistance device 200 may obtain joint angle information based on the sensor data and identify a motion corresponding to the joint angle information. If a joint angle change repeats within a predetermined margin of error, the walking assistance device 200 may verify that the user is currently repeating a predetermined motion.

For example, it may be assumed that the user is performing a squat exercise 440 while wearing the walking assistance device 200. Diagram 450 may be a graph of the joint angle over time in this situation. Referring to Diagram 450, the joint angle increases from θ1 to θ2 in a time period T1, the joint angle decreases from θ2 to θ3 in a time period T2, and the joint angle increases from θ3 to θ4 in a time period T3. According to an embodiment, the walking assistance device 200 may compare (θ2−θ1) and (θ2−θ3) and compare (θ2−θ3) and (θ4−θ3), and may verify that, if the joint angle change is repeated within the predetermined margin of error, the user is currently repeating a predetermined motion (e.g., the squat exercise 440).

In response to the verification that the user is currently repeating the predetermined motion, the walking assistance device 200 may calculate a motion tempo. The walking assistance device 200 may calculate the motion tempo based on the joint angle change and the repetition period. For example, the walking assistance device 200 may calculate a motion tempo corresponding to each of the time periods T1, T2, and T3. Alternatively, the walking assistance device 200 may calculate the motion tempo using the average value of (θ2−θ1), (θ2−θ3), and (θ4−θ3) and the average value of T1, T2, and T3.

According to an embodiment, the walking assistance device 200 may compare the motion tempo with a threshold value, and verify that the walking assistance device 200 corresponds to the first state if the motion tempo exceeds the threshold value.

Referring back to FIG. 3, in operation 340, according to an embodiment, the walking assistance device 200 may determine a change control torque corresponding to at least one of the plurality of pieces of velocity information based on a result of the verifying. “Based on” as used herein covers based at least on.

According to an embodiment, the walking assistance device 200 may receive a current control torque, and change the current control torque to a change control torque to reduce an output torque load. According to an embodiment, the change control torque may vary depending on the extent of the magnitudes of the plurality of pieces of velocity information determined in operation 330. According to an embodiment, the walking assistance device 200 may vary the degree of decreasing the torque as the velocity increases, or may always set the change control torque to a predetermined value at a predetermined velocity or higher.

More specifically, according to an embodiment, the walking assistance device 200 may determine the change control torque corresponding to at least one of the current control torque and the plurality of pieces of velocity information using a lookup table. According to an embodiment, the lookup table may be generated for each of the plurality of pieces of velocity information.

For example, a first lookup table may store change control torque values corresponding to a plurality of joint velocity values and control torque values, respectively, a second lookup table may store change control torque values corresponding to a plurality of walk speed values and control torque values, respectively, a third lookup table may store change control torque values corresponding to a plurality of power values and control torque values, respectively, and a fourth lookup table may store change control torque values corresponding to a plurality of motion tempo values and control torque values, respectively.

According to an embodiment, the walking assistance device 200 may determine a derating ratio corresponding to at least one of the plurality of pieces of velocity information, and determine the change control torque by multiplying the current control torque by the derating ratio.

In operation 350, according to an embodiment, the walking assistance device 200 may control the walking assistance device with the change control torque. According to an embodiment, the walking assistance device 200 may control the current or voltage of a motor so that a driving portion (e.g., the driving portion 110 of FIG. 1A) may operate with the change control torque.

Thereafter, according to an embodiment, the walking assistance device 200 may repeat operations 310 to 330 to verify whether the walking assistance device 200 still corresponds to the first state, and adjust the current control torque to a change control torque through operations 340 and 350 if the walking assistance device corresponds to the first state.

In repeating operations 340 and 350, a weight may be assigned according to the repetition count of determining the change control torque. For example, if the walking assistance device still corresponds to the first state even when the current control torque is adjusted to the change control torque, the weight determined according to the repetition count may be additionally applied to determine the change control torque value.

According to an embodiment, if the walking assistance device 200 operates at a normal velocity, the walking assistance device 200 may adjust the changed control torque value to a control torque value for the original resistance. To adjust the changed control torque value to the control torque value for the original resistance, according to an embodiment, the walking assistance device 200 may multiply the changed control torque value by a predetermined ratio, may directly set the changed control torque value to the original control torque value, or may use the lookup table.

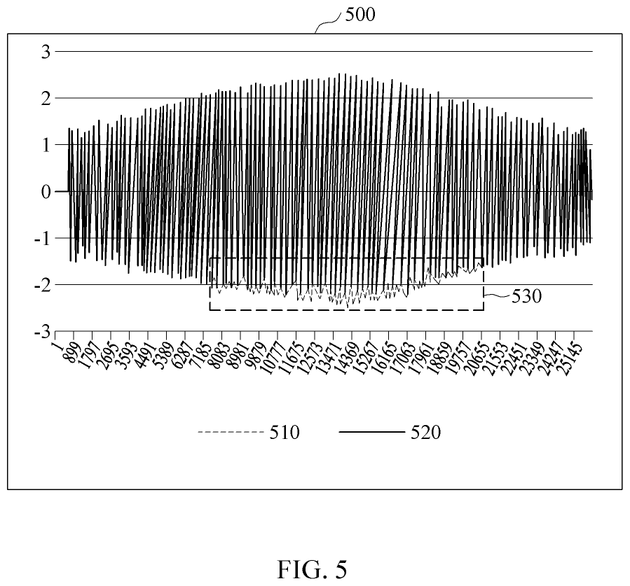

FIG. 5 is a diagram illustrating a current control torque and a change control torque according to an embodiment.

According to an embodiment, the walking assistance device 200 may change a current control torque to a change control torque if the walking assistance device corresponds to a first state. Referring to FIG. 5, Diagram 500 has the x-axis denoting time (milliseconds (ms)) and the y-axis denoting a torque value (Newton-meters (Nm)). Diagram 500 shows a first graph 510 and a second graph 520, wherein the first graph 510 shows the control torque value over time when a walking assistance device is not controlled with a change control torque according to an embodiment, and the second graph 520 shows the control torque value over time when the walking assistance device is controlled with a change control torque according to an embodiment.

Comparing the first graph 510 and the second graph 520, if the walking assistance device 200 does not correspond to a first state 530, the walking assistance device 200 may have the same torque value in the first graph 510 and the second graph 520, as the current control torque is used as is. However, if the walking assistance device 200 corresponds to the first state 530, the walking assistance device 200 may control the walking assistance device 200 with a change control torque which has a lower torque value than the current control torque, and thus, it may be observed that the torque value in the second graph 520 is lower than the torque value in the first graph 510.

The walking assistance device 200 may detect the first state 530, that is, the high-speed walking situation, and change the current control torque to the change control torque (e.g., the value lower than the current control torque) in response to the high-speed walking situation being detected, thereby reducing the load applied to the components (e.g., a drive motor and a reducer) included in the walking assistance device 200.

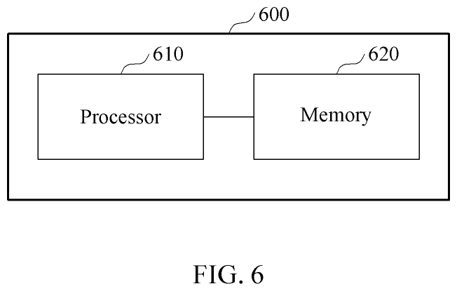

FIG. 6 is a block diagram illustrating an electronic device according to an embodiment.

Referring to FIG. 6, according to an embodiment, an electronic device 600 may include a processor 610 and a memory 630.

According to an embodiment, the processor 610 may obtain sensor data from one or more sensors, obtain a plurality of pieces of velocity information based on the sensor data, verify whether the walking assistance device corresponds to a first state based on at least one of the plurality of pieces of velocity information, and determine a change control torque corresponding to at least one of the plurality of pieces of velocity information based on a result of the verifying.

According to an embodiment, the memory 630 may be volatile memory or non-volatile memory, and the processor 610 may execute a program and control the electronic device 600. Program code to be executed by the processor 610 may be stored in the memory 630. The electronic device 600 may be connected to an external device through an input/output device (not shown) and exchange data with the external device. The electronic device 600 may be mounted on various computing devices and/or systems, such as a walking assistance device (e.g., the walking assistance device 200 of FIG. 2), a smartphone, a tablet computer, a laptop computer, a desktop computer, a television, a wearable device, a security system, and a smart home system. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.communication mo

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

A number of embodiments have been described above. Nevertheless, it should be understood that various modifications and variations may be made to these embodiments. For example, suitable results may be achieved if the described techniques are performed in a different order, and/or if components in a described system, architecture, device, or circuit are combined in a different manner, and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Accordingly, other implementations, other embodiments, and equivalents to the claims are also within the scope of the following claims.

1. A control method of a walking assistance device, the control method comprising:
obtaining sensor data from at least one sensor;
obtaining a plurality of pieces of velocity information based on the sensor data;
verifying whether the walking assistance device corresponds to a first state based on at least one of the plurality of pieces of velocity information;
determining a change control torque based on at least one of the plurality of pieces of velocity information based on a result of the verifying; and
controlling the walking assistance device with the change control torque.

2. The control method of claim 1, wherein the obtaining of the plurality of pieces of velocity information comprises obtaining at least one of: joint velocity information, walk speed information, power information, and motion tempo information, based on the sensor data.

3. The control method of claim 1, wherein the obtaining of the plurality of pieces of velocity information comprises:
obtaining joint angle information based on the sensor data; and
obtaining motion tempo information based on the joint angle information.

4. The control method of claim 3, wherein the obtaining of the motion tempo information comprises:
identifying a motion corresponding to the joint angle information;
obtaining count information corresponding to the motion; and
obtaining the motion tempo information based on the count information.

5. The control method of claim 1, further comprising:
receiving a current control torque,
wherein the determining of the control torque comprises determining the change control torque based on at least one of the current control torque and the plurality of pieces of velocity information, using at least a lookup table.

6. The control method of claim 1, further comprising:
receiving a current control torque,
wherein the determining of the control torque comprises:
determining a derating ratio based on at least one of the plurality of pieces of velocity information; and
determining the change control torque at least by multiplying the current control torque by the derating ratio.

7. The control method of claim 1, wherein the verifying comprises:
comparing each of the plurality of pieces of velocity information with a threshold value corresponding to each of the plurality of pieces of velocity information; and
verifying that the walking assistance device corresponds to the first state, when at least one of the plurality of pieces of velocity information exceeds the threshold value.

8. A computer program stored in a non-transitory storage medium, configured to perform the method of claim 1 in combination with hardware.

9. An electronic device of a walking assistance device, comprising:
a memory configured to store at least one instruction; and
at least one processor, comprising processing circuitry, configured to execute the at least one instruction, and individually and/or collectively to:
obtain sensor data from at least one sensor,
obtain a plurality of pieces of velocity information based on the sensor data,
determine whether the walking assistance device corresponds to a first state based on at least one of the plurality of pieces of velocity information, and
determine a change control torque corresponding to at least one of the plurality of pieces of velocity information based on a result of the determination of whether the walking assistance device corresponds to the first state.

10. The electronic device of claim 9, wherein the at least one processor is configured to obtain at least one of joint velocity information, walk speed information, power information, and motion tempo information, based on the sensor data.

11. The electronic device of claim 9, wherein the at least one processor is configured to obtain joint angle information based on the sensor data, identify a motion corresponding to the joint angle information, obtain count information corresponding to the motion, and obtain the motion tempo information based on the count information.

12. The electronic device of claim 9, wherein the at least one processor is configured to receive a current control torque, and determine the change control torque based on at least one of the current control torque and the plurality of pieces of velocity information, using at least a lookup table.

13. The electronic device of claim 9, wherein the at least one processor is configured to receive a current control torque, determine a derating ratio corresponding to at least one of the plurality of pieces of velocity information, and determine the change control torque at least by multiplying the current control torque by the derating ratio.

14. The electronic device of claim 9, wherein the at least one processor is configured to compare each of the plurality of pieces of velocity information with a threshold value corresponding to each of the plurality of pieces of velocity information, and determine that the walking assistance device corresponds to the first state, when at least one of the plurality of pieces of velocity information exceeds the threshold value.

15. A walking assistance device comprising:
a sensor portion comprising at least one sensor;
a driving portion comprising a motor; and
a processor, comprising processing circuitry, configured to:
obtain sensor data from at least one sensor,
obtain a plurality of pieces of velocity information based on the sensor data,
determine whether the walking assistance device corresponds to a first state based on at least one of the plurality of pieces of velocity information, and
determine a change control torque, based on at least one of the plurality of pieces of velocity information, based on a result of the determination, wherein the driving portion is configured to provide the change control torque to assist walking of a user.
